(19) United States
(12) Patent Application Publication
(10) Pub. No.: US 2013/0064964 A1
(43) Pub. Date: Mar. 14, 2013

(54) MONOBASIC PYROPHOSPHATE MATERIALS FOR REDUCING ACRYLAMIDE CONTENT IN FOOD

(71) Applicants: YAN HUANG, North Brunswick, NJ (US); RUSSELL KEMP, Robbinsville, NJ (US)

(72) Inventors: YAN HUANG, North Brunswick, NJ (US); RUSSELL KEMP, Robbinsville, NJ (US)

(73) Assignee: INNOPHOS, INC., Cranbury, NJ (US)

(21) Appl. No.: 13/029,091

(22) Filed: Feb. 16, 2011

(51) Int. Cl. A23L 1/30

(52) U.S. Cl. 426/654

(57) ABSTRACT

The present invention relates to a material for reducing acrylamide content in foods having the formula:

(MₓH_{y})⁺⁴(P₂O₇)⁻⁴:

where M is a cation selected from the group consisting of monovalent cations, divalent cations, and trivalent cation; H is hydrogen, P₂O₇ is the pyrophosphate anion, and y is a number between 2.2-3.8; and x is a value sufficient to balance the overall charge of said compound.

### BACKGROUND OF THE INVENTION

(1) Field of the Invention

The present invention relates to monobasic pyrophosphate compounds for reducing acrylamide content in carbohydrate rich foods.

Since the dawn of civilization, carbohydrate-containing foods have been a staple in man's diet. Today, carbohydrate-containing foods such as breads, breakfast cereals, biscuits, crackers, cookies, French fries, cooked starchy vegetables, taco shells, and snack foods are popularly consumed. Although such foods have been part of the human diet for years, researchers have only recently discovered that many of these foods contain acrylamide.

In April 2002, the Swedish National Food Administration and researchers from Stockholm University announced their findings that acrylamide, a potentially cancer-causing chemical, is formed in many types of cooked foods. Acrylamide has a carcinogenic potency in rats that is similar to that of other carcinogens in food, but for humans, the relative potency in food is not known. Only limited human population data are available for acrylamide and these provide no evidence of cancer risk from occupational exposure. (FAO/WHO Consultation on the Health Implications of Acrylamide in Food: Summary Report; Geneva, Switzerland, 25 27 Jun. 2002.)

A pathway for the formation of acrylamide from amino acids and reducing sugars as a result of the Maillard reaction has been proposed by Mottram, et al. in Nature 419:448 (2002). According to this hypothesis, acrylamide may be formed during the Maillard reaction. During baking and roasting, the Maillard reaction is mainly responsible for the color, smell and taste of the final product. A side reaction associated with the Maillard reaction is the Strecker degradation of amino acids and a possible pathway to acrylamide formation. The formation of acrylamide became detectable when the temperature exceeded 120.degree. C., and the highest formation rate was observed at around 170.degree. C. When asparagine (an amino acid) and glucose (a reducing sugar) were present, the highest levels of acrylamide could be observed, while glutamine and aspartic acid only resulted in trace quantities. The fact that acrylamide is formed mainly from asparagine (combined with reducing sugars) is thought to explain the high levels of acrylamide in oven-cooked or roasted plant products. Several plant raw materials are known to contain substantial levels of asparagine. In potatoes asparagine is the predominant free amino acid (940 mg/kg, corresponding with 40% of the total amino-acid content) and in wheat flour asparagine is present as a level of about 167 mg/kg, corresponding with 14% of the total free amino acids pool (Belitz and Grosch in Food Chemistry—Springer New York, 1999).

Although further research is needed to assess what health effects, if any, may result from human consumption of acrylamide at the levels commonly found in such foods, many consumers and regulatory agencies have voiced concern. For example, Proposition 65, known officially as the Safe Drinking Water and Toxic Enforcement Act of 1986, was a ballot initiative that was approved by California voters in 1986. OEHHA is the lead agency for the implementation of Proposition 65, which requires the state to maintain a list of substances that are known to cause cancer, birth defects or other reproductive harm. Currently, there are more than 750 substances on this list, including acrylamide. Further, Canada has also updated its risk management strategy for acrylamide.

(2) Description of the Related Art

Considerable efforts have been directed to addressing these consumer and regulatory concerns. The Confederation of Food and Drink Industries of the European Union (CIAA) has published a “toolbox” describing ways to reduce acrylamide in fried potato products. For example, the CIAA recommends adding SAPP (sodium acid pyrophosphate-Na₂H₂P₂O₇) during the last stage of a water blanching pretreatment as a proven acrylamide reduction measure.

US 2006/0240174 discloses a method for reducing acrylamides in fried carbohydrate foods, such as potatoes, comprising treating said foods with a pH lowering agent. Examples of the pH-lowering agent, which can be used in the 2006/0240174 invention, include an organic acid or its salt, a buffer solution containing the organic acid or its salt, an inorganic acid or its salt, a buffer solution containing the inorganic acid or its salt, a fruit juice, and mixtures thereof. Examples of such organic acids include citric acid, malic acid, acetic acid, lactic acid, succinic acid, tartaric acid, ascorbic acid, and adipic acid. Preferably, citric acid is used. Examples of inorganic acids include phosphoric acid, hydrochloric acid, sulfuric acid and pyrophosphoric acid. Examples of salts of inorganic acid include monosodium phosphate and monopotassium phosphate. Citric acid-sodium citrate buffer solution or citric acid-sodium phosphate buffer can be used as the buffer solution containing the organic acid or its salt. Sodium phosphate or potassium phosphate buffer solution can be used as the buffer solution containing inorganic acid or its salt. Examples of fruit juices include lemon, plum, orange, apricot, citron and lime juices, which have high organic acid content.

US Application 2007/0141225 discloses methods for reducing acrylamide in thermally processed foods such as potatoes. Said methods include treating the thermally processed foods with asparaginase and at least one other acrylamide reducing agent such as a free amino acid (e.g cysteine, lysine, glycine), cations having a valence of at least 2 (e.g Calcium chloride and Magnesium chloride), food grade acids (e.g phosphoric acid), food grade bases (lime solution of pH 9), and a free thiol compound (e.g cysteine, N-acetyl L-cysteine, N-acetyl cysteine, di-thiothreitol and casein). Also noted is the fact that monovalent cations do not reduce acrylamide.

Finally, Pedreschi, et al disclose that acrylamide formation in French Fries can be reduced by: (1) pre frying immersion in distilled water; (2) pre frying immersion in citric acid, and (3) prefrying hot water blanching. Conversely, pre frying immersion in sodium pyrophosphate (i.e sodium tetrapyrophosphate—Na₄P₂O₇) did not significantly reduce acrylamide formation. See, Pedreschi, et al (2007) Acrylamide Reduction under Different Pre Treatments in French Fries. Journal of Food Engineering, 79, 1287-1294.

Now, Applicants have contributed to the art with their discovery of monobasic pyrophosphate materials useful in reducing acrylamide content in carbohydrate rich foods.

### BRIEF DESCRIPTION OF THE DRAWINGS

FIG. 1 is an x-ray diffractometer pattern illustrating the practice of the present invention.

FIG. 2 is an x-ray diffractometer pattern illustrating the practice of the present invention.

FIG. 3 is an x-ray diffractometer pattern illustrating the practice of the present invention.

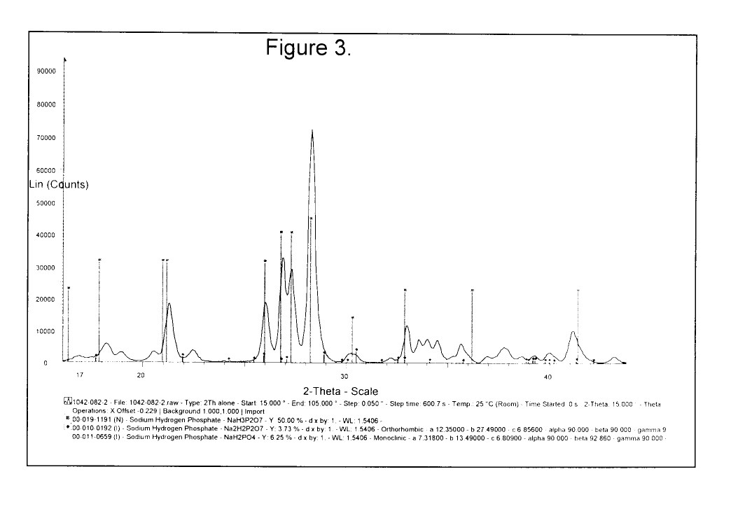

FIG. 4—Acrylamide content of French fries (potato strips soaked in 1% solution at room temperature for 35 min)

FIG. 5—Acrylamide content of French fries (potato strips blanched in water after 65° C. for 20 min and soaked in a 1% solution at room temperature for 10 min)

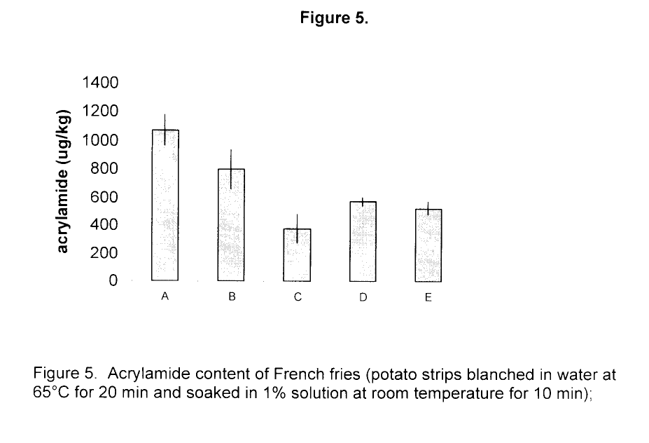

### SUMMARY OF THE INVENTION

The present invention relates to a material for reducing acrylamide content in foods having the formula:

(MₓH_{y})⁺⁴(P₂O₇)⁻⁴:

where M is a cation selected from the group consisting of monovalent cations, divalent cations, and trivalent cations; H is hydrogen, P₂O₇ is the pyrophosphate anion, and y is a number between 2.2 and 3.8; and x is a value sufficient to balance the overall charge of said compound.

The present invention also relates to a material for reducing acrylamide content in foods having the formula:

(MₓH_{y})⁺⁴(P₂O₇)⁻⁴:

where M is a cation selected from the group consisting of monovalent cations, divalent cations, and trivalent cations; H is hydrogen, P₂O₇ is the pyrophosphate anion, and y is a number between 2.2 and 3.8, and wherein further if M is a monovalent cation, then x=4−y; further provided if M is a divalent cation, then x=(4−y)/2; wherein further if M is a trivalent cation, then x=(4−y)/3.

### DEFINITIONS AND USAGES OF TERMS

Cations are positively charged dissolved elements which will normally try to combine with or attach to an anion.

The term “ mixing ” as used herein means mixing of sufficient intensity to mix high viscosity materials, said materials having viscosities equal to or greater than 200,000 cps (centipois)

The term “heating” as used herein means heating to a temperature range of 110-180 C. In another embodiment, heating may occur at 120-170 C, and in a further embodiment, heating may occur at 160 C.

“Polyphosphoric acid” (PPA) is a clear viscous liquid comprised of a mixture of ortho, pyro, tri, tetra and higher condensed acids of the general formula Hn+2PnO₃n+1”. In the practice of the present invention, 105-112% polyphosphoric acid, on a H₃PO₄ basis, is used. The degree of condensation is often referred to in terms of “percent phosphoric acid”, for example 108% PPA” (phosphoric acid basis) is equivalent to 78% on a P₂O₅ (diphosphorous pentoxide) basis.

“Pyrophosphoric acid” is H₄P₂O₇. It is a solid a room temperature.

Orthophosphoric acid is H₃PO₄

Tripolyphosphoric acid is H₅P₃O₁₀

Tetrapolyphosphoric acid is H₆P₄O₁₃

P₂O₇ is the pyrophosphate anion, also known as diphosphate.

The term “compound having a monovalent cation” refers to compounds including but not limited to SAPP (sodium acid pyrophosphate), KAPP (potassium acid pyrophosphate), Cuprous pyrophosphate, and ammonium pyrophosphate and sodium carbonate (Na₂CO₃). SAPP is a nonlimiting example of a compound having a monovalent metal cation. More specifically, SAPP is a dimetal dihydrogen pyrophosphate wherein the monovalent metal is sodium, and where in the acronym stands for sodium acid pyrophosphate. SAPP has the formula Na₂H₂P₂O_{7.}

The term “compound having a divalent cation” refers to compounds including, but not limited to metals oxides such as, MgO, CaO, ZnO, CrO, CuO, and MnO.

The term “compound having a trivalent cation” refers to compounds including, but not limited to metal oxides such as Al₂O₃ and Fe₂O_{3.}

### DETAILED DESCRIPTION OF THE INVENTION

The present invention relates to a material for reducing acrylamide content in foods having the formula:

(MₓH_{y})⁺⁴(P₂O₇)⁻⁴:

where M is a cation selected from the group consisting of monovalent cations, divalent cations, and trivalent cation; H is hydrogen, P₂O₇ is the pyrophosphate anion, and y is a number between 2.2-3.8; and x is a value sufficient to balance the overall charge of said compound.

The present invention relates to a material for reducing acrylamide content in foods having the formula:

(MₓH_{y})⁺⁴(P₂O₇)⁻⁴:

where M is a cation selected from the group consisting of monovalent cations, divalent cations, and trivalent cation; H is hydrogen, P₂O₇ is the pyrophosphate anion, and y is a number between 2.2 and 3.8, and wherein further if M is a monovalent cation, then x=4−y; further provided if M is a divalent cation, then x=(4−y)/2; wherein further if M is a trivalent cation, then x=(4−y)/3”.

### NON LIMITING EXAMPLES OF THE MONOBASIC PYROPHOSPHATE MATERIALS OF THE PRESENT INVENTION

Monovalent Monometal Pyrophosphates

Monosodium hydrogen pyrophosphate —(NaH₃)⁺⁴(P₂O₇)⁻⁴

Monopotassium hydrogen pyrophosphate —(KH₃)⁺⁴(P₂O₇)⁻⁴

MonoAmmonium hydrogen pyrophosphate —(NH₄H₃₎⁺⁴(P₂O₇)⁻⁴

Monocupric hydrogen pyrophosphate —(CuH₃₎⁺⁴(P₂O₇)⁻⁴

Divalent Monometal Pyrophosphates

Monocalcium hydrogen dipyrophosphate —(CaH₆)⁺⁸((P₂O₇)⁻⁴)₂

Monomagnesium hydrogen dipyrophosphate (MgH₆)⁺⁸((P₂O₇)⁻⁴)₂

Monozinc hydrogen dipyrophosphate —(ZnH₆)⁺⁸((P₂O₇)⁻⁴)₂

Monochromium hydrogen dipyrophosphate —(ZnH₆)⁺⁸((P₂O₇)⁻⁴)₂

Monocupric hydrogen dipyrophosphate —(CuH₆)((P₂O₇)⁻⁴)₂

Monomanganese hydrogen dipyrophosphate —(MnH₆)((P₂O₇)⁻⁴)₂

Trivalent Monometal Pyrophosphates

Monoaluminium hydrogen tripyrophosphate —(AlH₉)⁺¹²((P₂O₇)⁻⁴)₃

Monoferric hydrogen tripyrophosphate —(FeH₉)⁺¹²((P₂O₇)⁻⁴)₃

Preparing the Monobasic Pyrophosphate Materials of the Present Invention:

In an embodiment of the invention, 108% polyphosphoric acid (PPA) or pyrophosphoric acid (H₄P₂O₇) is mixed with equal parts (molar) of SAPP (Na₂H₂P₂O₇) and heated to 160 C to form NaH₃P₂O₇ (monosodium hydrogen pyrophosphate).

In another embodiment of the invention, pyrophosphoric acid (H₄P₂O₇) or 105% PPA is mixed with a metal oxide powder, wherein said metal species is divalent, such as MgO, and heated at 160 C to form monomagnesium hydrogen dipyrophosphate

In yet another embodiment of the invention, pyrophosphoric acid (H₄P₂O₇) or 110% PPA is mixed with a metal oxide powder, wherein said metal species is trivalent, such as Fe₂O₃, and heated at 160 C to form monoferric hydrogen tripyrophosphate

In an embodiment of the invention, heating is conducted at a temperature range of about 110-180 C. In another embodiment, said temperature range is 120-170 C. In yet another embodiment, the temperature is 160 C.

In a further embodiment of the invention, 105-112% PPA is comprised of the following percentages of acid species:

Orthophosphoric acid species—less than or equal to 40%

Pyrophosphoric acid species—40-50%

The following non limiting Examples illustrate the practice of the present invention.

Examples 1-7 were prepared with solid pyrophosphoric acid (H₄P₂O₇) which is a solid at room temperature.

### Example 1

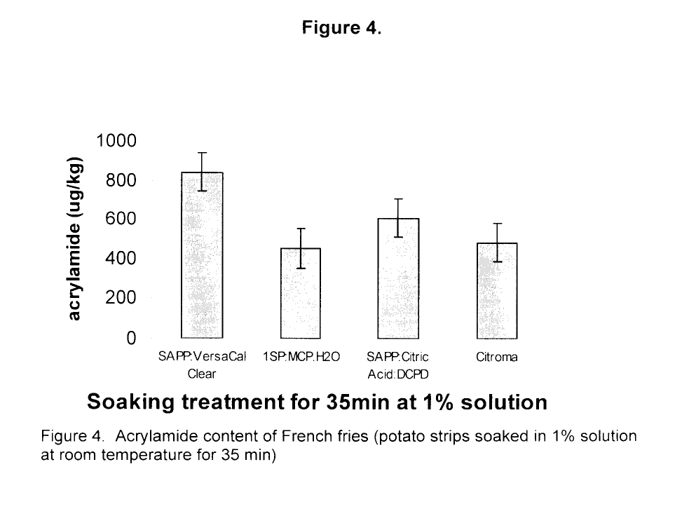

### Figure 1024-007-4H

374.38 g of sodium acid pyrophosphate (SAPP) was added to the mixing bowl of a Cuisinart® food processor equipped with a chopping blade. 300.63 g of solid H₄P₂O₇ (pyrophosphoric acid) was then added to the SAPP in said mixing bowl. The food processor cover was put in place and the SAPP and the solid H₄P₂O₇ were mixed together by the chopping action of the blade. The sides and the bottom of the food processor were occasionally scraped to remove product that had clumped up. The SAPP/solid H₄P₂O₇ mixture became a dry blend at first, and then the heat of reaction caused the mixture to form a wet pasty solid. As mixing continued, this paste continued to solidify. Upon further mixing the hardened solid was chopped up into small granules. The resultant granular product was placed in a glass dish and dried in a 160 C oven for 4 hours. The product yield was 97.6%. Final sample had 15.7% PO₄ and 84% P₂O₇ with a 96.6% assay by IC analysis. The pH of a 1% (w/w) solution was 2.07, and the X-Ray Diffractometer (XRD) profile closely matched that expected from pure monosodium pyrophosphate.

### Example 2

278.36 g of sodium acid pyrophosphate (SAPP) was added to the mixing bowl of a Cuisinart® food processor equipped with a chopping blade. 223.13 g of solid H₄P₂O₇ was then added to the SAPP in said mixing bowl. The food processor cover was put in place and the SAPP and the solid H₄P₂O₇ were mixed together by the chopping action of the blade. The sides and the bottom of the food processor were occasionally scraped to remove product that had clumped up. The SAPP/solid H₄P₂O₇ mixture became a dry blend at first, and then the heat of reaction caused the mixture to form a wet pasty solid. As mixing continued, this paste continued to solidify. Upon further mixing the hardened solid was chopped up into small granules. The resultant granular product was placed in a glass dish and dried in a 160 C oven for 4 hours.

### Example 3

### Figure 1042-020

312.28 g of sodium acid pyrophosphate (SAPP) was added to the mixing bowl of a Cuisinart® food processor equipped with a chopping blade. 250.82 g of sold H₄P₂O₇was then added to the SAPP in the mixing bowl. The food processor cover was put in place and the SAPP and the solid H₄P₂O₇ were mixed together by the chopping action of the blade. The sides and the bottom of the food processor were occasionally scraped to remove product that had clumped up. The SAPP/solid H₄P₂O₇ mixture became a dry blend at first, and then the heat of reaction caused the mixture to form a wet pasty solid. As mixing continued, this paste continued to solidify. Upon further mixing the hardened solid was chopped up into small granules. The resultant granular product was placed in a glass dish and dried in a 160 C oven for 4 hours. The product yield was 93.0%. The sample heated for 5 hours had 8.9% PO₄ and 87.1% P₂O₇ with a 100.1% assay by IC analysis. The sample heated for 10 hours had 2.7% PO₄ and 93.6% P₂O₇ with a 107.6% assay. The XRD profile closely matched that expected from pure monosodium pyrophosphate.

### Example 4

124 g of sodium acid pyrophosphate (SAPP) was added to the mixing bowl of a Cuisinart® food processor equipped with a chopping blade. 100 g of solid H₄P₂O₇ was then added to the SAPP in the mixing bowl. The cover was placed on the mixing bowl and the SAPP and solid H₄P₂O₇ were mixed by chopping. Mixing continued until a dry blend was formed. Said dry blend was placed in a glass dish and dried in a 160 C oven for 6 hours.

### Example 5

312.38 g of sodium acid pyrophosphate (SAPP) was added to the mixing bowl of a Cuisinart® food processor equipped with a chopping blade. 251.15 g of solid H₄P₂O₇ was then added to the SAPP in the mixing bowl. The food processor cover was put in place and the SAPP and the solid H₄P₂O₇ were mixed together by the chopping action of the blade. The sides and the bottom of the food processor were occasionally scraped to remove product that had clumped up. The SAPP/solid H₄P₂O₇ mixture became a dry blend at first, and then, the heat of reaction caused the mixture to form a wet pasty solid. As mixing continued, this paste continued to solidify. Upon further mixing the hardened solid was chopped up into small granules. The resultant granular product was placed in a glass dish and dried in a 160 C oven for 20 hours. The product yield was 96%. Final sample had 1.2% PO₄ and 94.2% P₂O₇ with a 108.3% assay by IC analysis. The pH of a 1% (w/w) solution was 2.15.

### Example 6

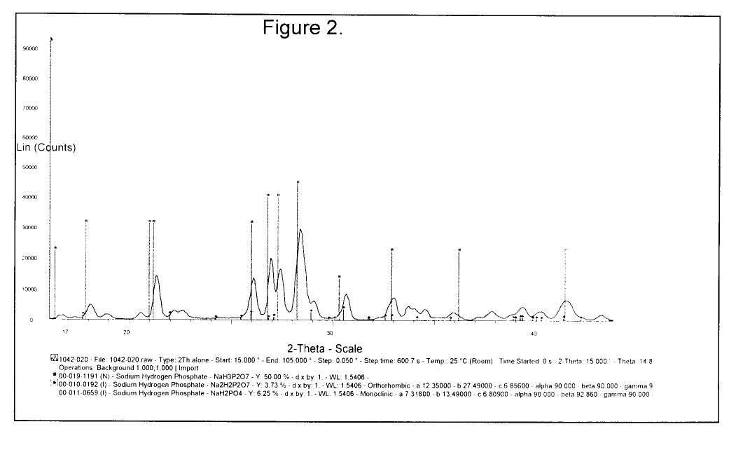

### Figure 1042-082-2

312.91 g of sodium acid pyrophosphate (SAPP) was added to the mixing bowl of a Cuisinart® food processor equipped with a chopping blade. 250.96 g of solid H₄P₂O₇ was then added to the SAPP in the mixing bowl. The food processor cover was put in place and the SAPP and solid H₄P₂O₇ were mixed by chopping. The bottom and sides of the mixing bowl were scraped to remove product that had clumped up. The mixture became a dry blend at first, and then, due to the heat of reaction, turned into a wet pasty solid. As mixing continued, this paste continued to solidify. Upon further mixing, said hardened, solid product was chopped up into small granules. The resultant solid product was then placed in a glass dish and dried in a 160 C oven for 20 hours. The product yield was 95%. Final sample had 1.4% PO₄ and 93.9% P₂O₇ with a 107.9% assay by IC analysis. The pH of a 1% (w/w) solution was 2.17, and the XRD profile closely matched that expected from pure monosodium pyrophosphate.

### Example 7

100.81 g of sodium acid pyrophosphate (SAPP) was added to the mixing bowl of a Cuisinart® food processor equipped with a chopping blade.100.86 g of solid H₄P₂O₇ was then added to the SAPP in the mixing bowl. The food processor cover was put in place and the SAPP and solid H₄P₂O₇ were mixed by chopping. The bottom and sides of the mixing bowl were scraped to remove product that had clumped up. The mixture became a dry blend at first, and then, due to the heat of reaction, turned into a wet pasty solid. As mixing continued, this paste continued to solidify. Upon further mixing, said hardened, solid product was chopped up into small granules. The resultant solid product was then placed in a glass dish and dried in a 160 C oven for 20 hours.

The following Examples 1, 2 and 3 were prepared with 108% liquid polyphosphoric acid (PPA)

### Example 1

124.65 g of sodium acid pyrophosphate (SAPP) was added to the mixing bowl of a Cuisinart® art food processor equipped with a chopping blade. 102.15 g of 108% polyphosphoric acid (PPA) was then added to the SAPP in the mixing bowl. The food processor cover was put in place and the SAPP and the 108% polyphosphoric acid (PPA) were mixed by chopping. The bottom and sides of the food processor were occasionally scraped during mixing to remove product that had clumped up. The mixture became a dry blend at first, and then formed small balls. As mixing continued these small balls became bigger and formed one clump that turned into a wet taffy-like solid. Mixing was continued until the processor could no longer mix the product. The product was placed in a glass dish and then heated in an oven at 160 C for 22 hours Final sample had 2% PO₄ and 90.4% P₂O₇ with a 103.9% assay by IC analysis. The pH of a 1% (w/w) solution was 2.01.

### Example 2

124.48 g of sodium acid pyrophosphate (SAPP) was added to a tall beaker. 103.99 g of 108% polyphosphoric acid (PPA) was then added to the beaker containing the SAPP. The SAPP and 108% polyphosphoric acid (PPA) were mixed by hand using a spatula. The mixture became a dry blend at first and then clumped up. Said clump could be pulled apart and had a sticky and stretchy consistency similar to taffy. This resultant product was placed in a glass dish and then in an oven at 110 C. After 10 minutes the taffy-like solid product was a pasty liquid. After 3 hr and 45 minutes of being in the oven, the product was one dry solid piece. Said solid piece was ground up into smaller chunks and placed in an oven at 160 C for 6 hours.

### Example 3

191.50 g sodium acid pyrophosphate (SAPP) was added to the mixing bowl of a Kitchen Aide® mixer. 154.59 g of 108% polyphosphoric acid (PPA) was slowly, by spoonful, added to the SAPP in the mixing bowl. The mixture slowly started to clump into small balls and then formed one big ball. Mixing stalled until the ball was broken up by a spatula. As the ball sat, it turned into a wet paste that stuck to the sides of the mixing bowl. The sides and bottom of the bowl were occasionally scraped as mixing of the wet paste continued. The product heated up a little but did not dry out. Said product was then placed in a glass dish in a 160 C oven for 3 hrs. Said oven heated product was a dry solid that could be crushed to a powder.

Use of the Materials of the Present Invention in Preparing Carbohydrate Rich Foods.

The materials of the present invention are useful in reducing acrylamide levels in high temperature processed carbohydrate rich foods including, but not limited to, French fried potatoes and other potato products. The materials of the present invention were tested in potatoes alongside currently available acrylamide reducing methods and materials.

The following 1% solutions were prepared:

Solution 1—Solution 1 is a blend of 66.67% SAPP and 33.33% Versa Cal Clear® (VC)

Solution 2 is an embodiment of the present invention. Said Solution 2 is a blend of 66.67% monosodiumhydrogenpyrophosphate and 33.33% MCP.H2O (Regent 12xx)

Solution 3—Solution 3 is a blend of 40% SAPP, 20% DCPD, and 40% citric acid;

Solution 4. Citroma®

Solutions 1, 2, 3, and 4 were prepared and diluted to concentrations of 1%.

VersaCal® Clear is a soluble Monocalcium Phosphate and a registered Trademark of Innophos, Inc., Cranbury, N.J.

Citroma® is a commercially available proprietary acrylamide inhibitor chemical from Jungbunzlauer, Inc. It is thought to be monosodium citrate

Regent® 12XX is monocalcium phosphate.

DCPD is dicalcium phosphate dihydrate.

Potatoes were processed according to Methods 1 and 2.

Method 1

Potatoes were cut into strips (0.85×0.85 cm) using a French fry cutter and the strip length was adjusted to 7 cm. The strips were then soaked in 1% solutions of Solution 1, 2, 3, and 4. The soaked strips were then fried at 190° C. for 5 min.

Method 2

Potato strips (the strips were cut the same way as in Method 1) were first blanched in distilled water at 65° C. for 20 min. After blanching, the strips were divided into 5 lots. One lot was soaked in distilled water as a control. Other strips were soaked in Solutions 1-4. Soaking was done for 10 min. at room temperature. Potato strips were withdrawn from the solutions and drained for 2 min prior to frying at 190° C. for 2 min. The potato strips were cooled down and frozen for 2 days before re-frying at 190° C. for an additional 2 min. Frying temperature was maintained at a constant level since the potato mass to oil mass ratio (g/g) was kept low (˜0.001333).

Acrylamide Analysis

Acrylamide Formation in French Fries Using Processing Method 1

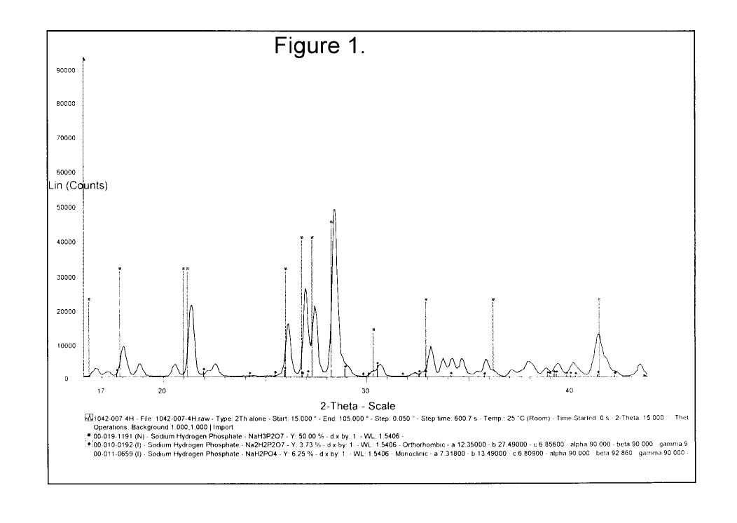

This procedure closely resembles the French fry process in establishments where products are made in one step from fresh potatoes. Immersion in Solution 2 (an embodiment of the present invention, being a blend of 66.67% monosodium hydrogen pyrophosphate and 33.33% MCP.H2O (Regent 12xx)) for 35 min at room temperature was the most effective pre-treatment in reducing acrylamide formation in French fries compared to soaking in other solutions including Citroma® (FIG. 1). The designation 1-SP in FIG. 1 stands for monosodium hydrogen pyrophosphate, a compound of the present invention.

FIG. 1. Acrylamide content of French fries (potato strips soaked in 1% solution at room temperature for 35 min)

FIG. 2. Acrylamide content of French fries (potato strips blanched in water at 65° C. for 20 min and soaked in 1% solution at room temperature for 10 min);

A: Water

B: 2 SAPP:1VersaCal® Clear

C: An embodiment of the present invention: 2 1SP:1 MCP.H₂O.

D: 2SAPP:2 Citric Acid:1DCPD

E: Citroma®

Note: 1-SP stands for monosodium hydrogen pyrophosphate, a compound of the present invention.

Acrylamide Formation in French Fries Using Processing Method 2

A process similar to that widely used in the consumer French fry industry was also carried out (processing Method 2). This was done to investigate if the above phosphate blends, which had the beneficial effect on acrylamide reduction in process 1 (FIG. 1), have the same effect as in an industrial procedure. FIG. 2 and Table 1 show that average acrylamide content for the control (soaked in water) was 1074 μg/kg in French fries. However, the acrylamide amount was significantly lowered by soaking with different phosphate blends (P<0.05). Among the phosphate blends, the potato strips which had been pre-treated with a 1% solution of a 2:1 ratio of 1SP to MCP.H₂O, an embodiment of the present invention, had only about ⅓ (65% reduction) of the acrylamide amount detected in the water soaked sample (control). Other treatments showed a higher level of acrlyamide, but still lower than the control.

TABLE 1
Impact of addition of several components on the pH and acrylamide
content in French fries

| | | | | % change in |
|---|---|---|---|---|
| | | | | acrylamide |
| | | | | content |
| | | pH | Acrylamide | compared |
| Added | pH of | of final | content | to water |
| Component | solution | product | (μg · kg⁻¹⁾ | treatment |
| water | | 5.38 | 1074 ± 107.5 | |
| SAPP + VersaCal ® | 3.39 | 5.23 | 802.5 ± 137.5 | 25.3 c* |
| Clear | | | | |
| 1SP + MCP•H2O | 2.01 | 4.81 | 377.5 ± 102.5 | 64.9 a |
| (an embodiment | | | | |
| of the present | | | | |
| invention) | | | | |
| SAPP + Citric | 3.27 | 5.01 | 575 ± 29.7 | 46.5 b |
| Acid + DCPD | | | | |
| Citroma | 3.24 | 4.90 | 528 ± 45.3 | 50.8 b |

*Different letters in the same column indicate significant difference (P < 0.05) by Duncan's New Range Multiple test.

We claim:

1. A compound for reducing acrylamide content in foods having the formula:
(MₓH_{y})⁺⁴(P₂O₇)⁻⁴:
where M is a cation selected from the group consisting of monovalent cations, divalent cations, and trivalent cation; H is hydrogen, P₂O₇ is the pyrophosphate anion, and y is a number between 2.2-3.8; and x is a value sufficient to balance the overall charge of said compound.

2. A compound for reducing acrylamide content in foods having the formula:
(MₓH_{y})⁺⁴(P₂O₇)⁻⁴:
where M is a cation selected from the group consisting of monovalent cations, divalent cations, and trivalent cation; H is hydrogen, P₂O₇ is the pyrophosphate anion, and y is a number between 2.2 and 3.8, and wherein further if M is a monovalent cation, then x=4−y; further provided if M is a divalent cation, then x=(4−y)/2; wherein further if M is a trivalent cation, then x=(4−y)/3.
